(19) United States
(12) Patent Application Publication
(10) Pub. No.: US 2023/0177322 A1
(43) Pub. Date: Jun. 8, 2023

(54) NEURON CIRCUIT AND NEUROMORPHIC DEVICE FOR COMPENSATING FOR CHANGE IN SYNAPTIC PROPERTIES

(71) Applicant: SEOUL NATIONAL UNIVERSITY R&DB FOUNDATION, Seoul (KR)

(72) Inventors: Byung-Gook Park, Seoul (KR); Kyung Chul Park, Seoul (KR)

(21) Appl. No.: 18/162,617

(22) Filed: Jan. 31, 2023

Related U.S. Application Data
(63) Continuation of application No. PCT/KR2022/018047, filed on Nov. 16, 2022.

(30) Foreign Application Priority Data
Nov. 18, 2021 (KR) 10-2021-0159694
Jun. 14, 2022 (KR) 10-2022-0071872

(51) Int. Cl. G06N 3/063; G06N 3/049

(52) U.S. Cl. CPC G06N 3/063; G06N 3/049

(57) ABSTRACT

A neuromorphic device includes a synaptic array, and a neuron circuit connected to the synaptic array, configured to accumulate an output current of the synaptic array, and configured to output a spike pulse when the accumulated current exceeds a threshold value, wherein a discharge switching element for discharging the current accumulated in the neuron circuit includes a synaptic element of the same type as an element included in the synaptic array.

### BACKGROUND

### 1. Field

The present disclosure relates to a neuron circuit that may compensate for a change in synaptic properties and a neuromorphic device including the neuron circuit.

### 2. Description of the Related Art

Recently, research and development of a hardware-based neural network have been actively conducted along with development of a computing technology based on an artificial neural network.

Although the neural network that is currently being widely studied is started from imitation of a real biological nervous system (concepts of memory, learning, and inference) and adopts a similar network structure but is different from the real biological nervous system in various aspects such as signal transmission, information expression method, and learning method.

Meanwhile, a learning method that outperforms the known neural network has not been developed yet, and thus, a hardware-based spiking neural network (SNN), which operates almost identically to the real nervous system, is rarely used in the real industry. However, if synaptic weights are derived by using the known neural network and inferred by using the SNN method, a high-accuracy and ultra-low-power computing system may be implemented, and thus, research on this is being actively conducted.

When a neural network such as an SNN is implemented in hardware, a weight to be stored in a synaptic array may change according to a temperature change or time lapse, which inevitably leads to a decrease in inference accuracy.

In order to solve the problems of the related art, the present disclosure proposes a new technology capable of operating in consideration of a change in properties of a synaptic element that may occur in a hardware-based neural network (hereinafter, referred to as a neuromorphic device).

An example of the related art includes Korean Patent Publication No. 10-2019-0051766 (Title of Invention: Neuron Circuit, system and method for synapse weight learning).

### SUMMARY

An object of the present disclosure is to provide a neuromorphic device that may compensate for a change in properties of a synaptic element.

However, technical objects to be achieved by the present embodiment are not limited to the technical object described above, and there may be other technical problems.

According to an aspect of the present disclosure, a neuromorphic device includes a synaptic array, and a neuron circuit connected to the synaptic array, configured to accumulate an output current of the synaptic array, and configured to output a spike pulse when the accumulated current exceeds a threshold value, wherein a discharge switching element for discharging the current accumulated in the neuron circuit includes a synaptic element of the same type as an element included in the synaptic array.

According to another aspect of the present disclosure, a neuron circuit that is used in a neuromorphic device is provided in which the neuron circuit is coupled to a synaptic array and accumulates an output current of the synaptic array and outputs a spike pulse when the accumulated current exceeds a threshold value, and a discharge switching element for discharging the current accumulated in the neuron circuit includes a synaptic element of the same type as an element included in the synaptic array.

According to the present disclosure, a current output from the synaptic array is accumulated in a charging element, and a discharge operation of the charging element is performed by using a discharge switching element of the same type as a synaptic element, and thus, an effect of adjusting a gradient of an activation function in response to a change in external environment may be obtained. Through this method, it is possible to obtain an effect of improving the accuracy while performing inference by using a synaptic element in which weights of a machine learning model are stored.

The configuration of the present disclosure may be generally used in all neuron circuits, and thus, the present disclosure may be applied to all systems, such as a sensor, a spiking neural network, and a neural network using a pulse width modulation (PWM) method.

### BRIEF DESCRIPTION OF THE DRAWINGS

FIG. 1 is a block diagram illustrating a configuration of a neuromorphic device according to an embodiment of the present disclosure;

FIG. 2 is a block diagram illustrating another configuration of the neuromorphic device according to an embodiment of the present disclosure;

FIG. 3 illustrates a concept of adjusting a gradient of an activation function according to an embodiment of the present disclosure;

FIG. 4 is a circuit diagram illustrating the configuration of the neuromorphic device according to the embodiment of the present disclosure;

FIG. 5 is a graph illustrating a test result when using a neuron circuit according to an embodiment of the present disclosure;

FIG. 6 is a graph illustrating test results of the neuromorphic device according to the embodiment of the present disclosure; and

FIG. 7 is a graph illustrating test results of the neuromorphic device according to the embodiment of the present disclosure.

### DETAILED DESCRIPTION

Hereinafter, embodiments of the present disclosure will be described in detail with reference to the accompanying drawings such that those skilled in the art to which the present disclosure belongs may easily implement the present disclosure. However, the present disclosure may be embodied in various different forms and is not limited to the embodiments described herein. In addition, in order to clearly illustrate the present disclosure in the drawings, parts irrelevant to the descriptions are omitted, and similar reference numerals are attached to similar parts throughout the specification.

Throughout the specification, when a portion is “connected” or “coupled” to another portion, this includes not only a case of being “directly connected or coupled” but also a case of being “electrically connected” with another element interposed therebetween.

Throughout the specification, when a member is said to be located “on” another member, this includes not only a case in which the member is in contact with another member but also a case in which there is another member between the two members.

A neuromorphic device of the present disclosure is manufactured to simulate the human brain in hardware by using a semiconductor process and includes a synaptic element corresponding to a brain synapse, a neuronal circuit corresponding to neurons, and various peripheral circuits.

Hereinafter, embodiments of the present disclosure will be described in detail with reference to the accompanying drawings.

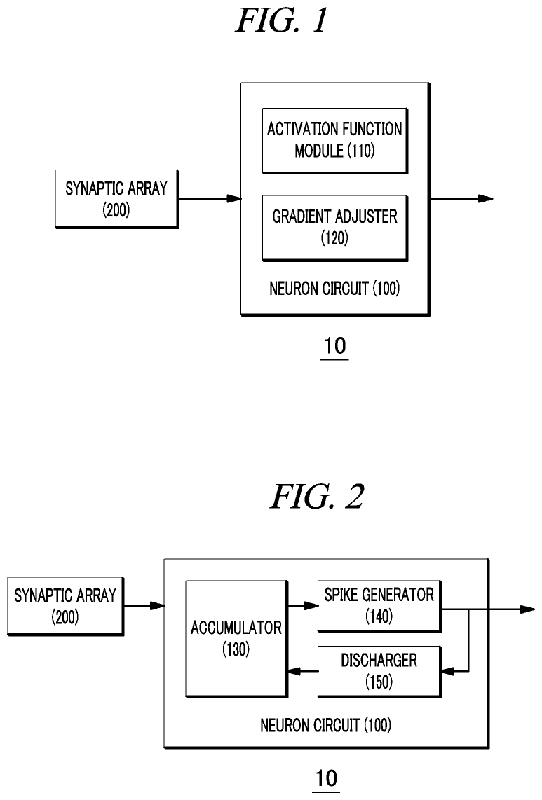

FIG. 1 is a block diagram illustrating a configuration of a neuromorphic device according to an embodiment of the present disclosure.

As illustrated, a neuromorphic device 10 includes a neuron circuit 100 and a synaptic array 200 connected to a front end of the neuron circuit 100.

The synaptic array 200 is implemented to perform the same function as synapses in the brain and is generally implemented based on a nonvolatile memory device. The synaptic array 200 corresponds to a plurality of synaptic cells and stores preset weights. The synaptic array 200 may include synaptic cells corresponding to a multiplication of the number of front-end neuron circuits and the number of rear-end neuron circuits, which are connected to each other. An operation of storing weights in the synaptic array 200 or a process of reading the stored weights is performed through the same principle as a program operation or a read operation performed by a general nonvolatile memory device. Here, the weight indicates a weight that is multiplied to an input signal of a perceptron structure indicating an artificial neural network model, and additionally, is defined as a concept including a bias which is a special weight having an input of 1.

The neuron circuit 100 includes an activation function module 110 and a gradient adjuster 120. The activation function module 110 may be implemented as a circuit for processing an activation function that converts an input through an artificial neural network and may be implemented as a circuit, which processes an activation function, such as a rectified linear unit (ReLU), a leaky ReLU (LReLU), and a parametric ReLU (PReLU).

The gradient adjuster 120 may compensate for a change in synaptic properties that may occur in a hardware neural network, and for example, the gradient adjuster 120 may compensate for a change in a weight stored in synapse according to a change in external environment, such as a change in temperature. In addition, retention of the synapse changes according to the change in the external environment, such as passage of time, and the gradient adjuster 120 may compensate for a change in weight stored in the synapse.

FIG. 2 is a block diagram illustrating another configuration of the neuromorphic device according to an embodiment of the present disclosure.

As illustrated in FIG. 2, the neuromorphic device 10 includes a neuron circuit 100 and a synaptic array 200. In this case, the neuron circuit 100 includes an accumulator 130, a spike generator 140, and a discharger 150 so as to implement functions of the activation function module 110 and the gradient adjuster 120. In addition, the neuron circuit 100 accumulates an output current of the synaptic array 200, and outputs a spike pulse when the accumulated value exceeds a threshold value.

The accumulator 130 accumulates a signal transmitted through an immediately preceding synapse or so on in a charging element, such as a capacitor.

When a charging voltage of the charging element is greater than or equal to a certain level, the spike generator 140 amplifies or maintains the charging voltage and transmits the charging voltage to an output terminal.

The discharger 150 discharges the charging element by using a discharge switching element during a spike generating operation of the spike generator 140. In this case, the discharge switching element includes a synaptic element that is the same type as an element constituting the synaptic array 200. The background of using the discharge switching element will be described in detail below.

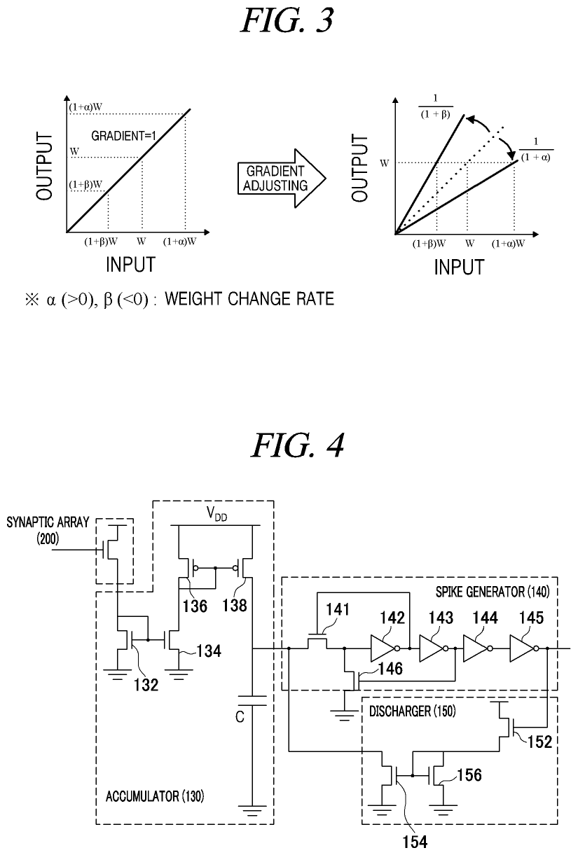

FIG. 3 illustrates a concept of adjusting a gradient of an activation function according to an embodiment of the present disclosure.

As described above, the present disclosure compensates for a change in the external environment affecting on a synaptic element. However, there is a problem in that an enormous amount of time and an additional system are required to check and compensate for the change in synaptic properties for every output.

In the present disclosure, a simple and effective synaptic change compensation method is implemented by paying attention to an input-output relationship of an activation function. That is, there is an effect that a gradient of an activation function is adjusted by the discharger 150 including synaptic elements of the same type.

For example, a ReLU function includes a one-dimensional graph of a gradient of 1, and accordingly, when a weight W changes by a certain ratio (1+α, or 1+β, where a is a positive number and 13 is a negative number), values output by the activation function also have distortion at the same rate when the gradient is fixed as in the related art.

Therefore, the present disclosure provides an effect of adjusting a gradient of an activation function by reflecting a change in external environment. That is, the gradient of the activation function is reduced such that the same output is provided even when an environmental change occurs in which a weight stored in a synapse increases, and the gradient of the activation function is increased such that the same output is provided even when an environmental change occurs in which the weight stored in the synapse decreases.

To this end, an element having the same change properties as a synaptic element is used as a switching element for discharge, and thus, an effect of adjusting a gradient of an activation function in which a change of the synaptic element is reflected may be obtained.

FIG. 4 is a circuit diagram illustrating a configuration of a neuromorphic device according to an embodiment of the present disclosure.

The accumulator 130 includes a plurality of switching elements 132, 134, 136, and 138 constituting a current mirror circuit, and a capacitor C as a charging element. With this configuration, a current output from the synaptic array 200 is accumulated in the charging element. The specific circuit configuration of the accumulator 130 is an example and may be implemented by another type of circuit known in the art.

The spike generator 140 includes a plurality of switching elements, that is a first switching element 141 and a second switching element 146 and a plurality of inverters, that is, a first inverter 142, a second inverter 143, a third inverter 144, and a fourth inverter 145 connected in series. Switching of the first switching element 141 is adjusted according to an output of the first inverter 142, and switching of the second switching element 146 is adjusted according to an output of the second inverter 143. With this configuration, when a voltage of the charging element increases to a preset level or higher, a charging voltage is transmitted through the first switching element 141 and the plurality of inverters and outputs as an output pulse type, that is, a spike pulse. In this case, the first switching element 141 and the second switching element 142 alternately perform a turn-on operation and a turn-off operation respectively by the outputs of the first inverter 142 and the second inverter 143.

The specific circuit configuration of the spike generator 140 is an example and may be implemented by another type of the known circuit including a comparator for comparing a charging voltage with a reference voltage, a circuit for generating a pulse signal, and so on.

The discharger 150 includes a discharge switching element 152 and a current mirror configured with a first switching element 154, and a second switching element 156. In this case, the discharge switching element 152 is switched by a voltage applied to an output terminal of the spike generator 140, thereby performing an operation of discharging the current accumulated in the neuron circuit. One terminal of the discharge switching element 152 is connected to a power supply terminal, and another terminal is connected to the second switching element 156. For example, the discharge switching element 152 may be implemented in the form of a MOS switching element having a gate connected to an output of the spike generator 140.

In addition, the first switching element 154 included in the current mirror has one terminal connected to an output terminal of the capacitor C and has another terminal that is grounded. The second switching element 156 has one terminal connected to another terminal of the discharge switching element 152 and has another terminal that is grounded.

With this configuration, the discharge switching element 152 is turned on in response to a signal with a high level output during a spike generating operation in which the spike generator 140 outputs a spike pulse, and the capacitor C is discharged according to the current mirror configuration. In this case, since the discharge switching element 152 is configured with the same type of switching element as the synaptic array 200, the discharge switching element 152 is equally affected by a change in external environment, and accordingly, the discharge switching element 152 has the same discharge characteristics as each synaptic element.

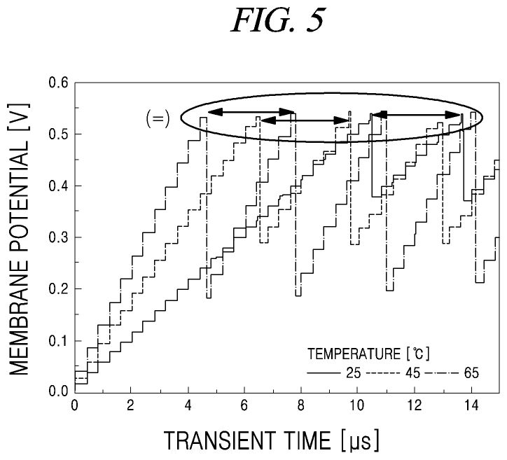

FIG. 5 is a graph illustrating a test result when using a neuron circuit according to an embodiment of the present disclosure.

It can be seen that, when external temperatures are 25° C. (a solid line), 45° C. (a dotted line), or 65° C. (a dashed line), rising gradients of a membrane potential of the charging element are different from each other depending on temperatures. That is, as the temperature increases, the rising gradient of the membrane potential increases, and since the discharge switching element 152 is also a synaptic element having the same temperature change characteristics, it can be seen that a current discharged for each temperature also increases. That is, when the external temperature is 25° C. (the solid line), the of discharging current is the smallest, and when the external temperature is 45° C. (the dotted line), the discharging current increases more, and when the external temperature is 65° C. (the dashed), the discharging current increases the most.

As such, it can be seen that the discharge switching element 152 also adjusts the discharging current of the charging element according to a change in external environment.

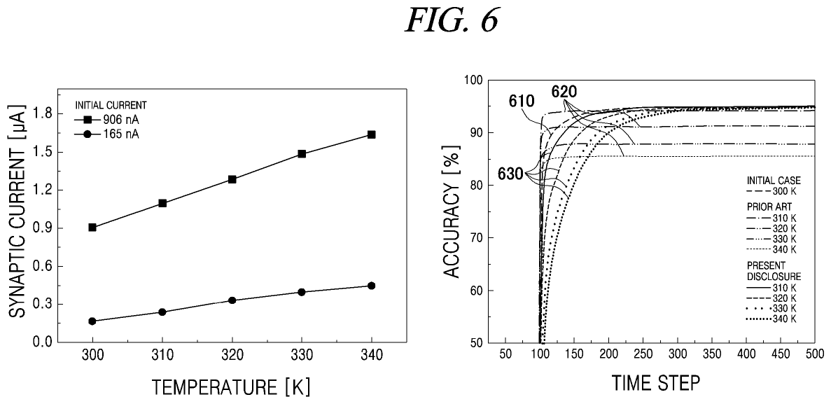

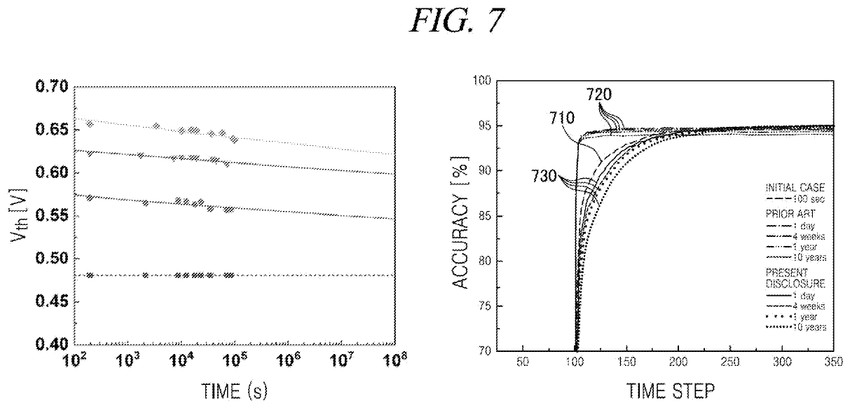

FIGS. 6 to 7 are graphs illustrating test results of a neuromorphic device according to an embodiment of the present disclosure.

FIG. 6 illustrates a case when the synapse is a resistive random access memory (RRAM) element, and the graph on the left shows a current of a synapse changes according to a change in temperature. In the graph on the right, it can be seen that accuracy of a neural network (SVHN inference network including 10 hidden layers) is reduced when the known technology in which a gradient of an activation function is fixed is used. In contrast to this, it can be seen that, when a charging element is discharged through the same type of discharge switching element (RRAM element) having the same change rate as the weight change according to the temperature as in the present disclosure, the accuracy is restored in an ideal state. In the graph on the right, 610 represents an initial state, 620 represents a method of discharging a certain amount according to the known art, and 630 represents a result according to the present disclosure.

FIG. 7 illustrates a case when the synapse is a polysilicon-based synaptic element, and the graph on the left shows a current of a synapse changes over time. In the graph on the right, it can be seen that the accuracy of a neural network is reduced when the known technology in which a gradient of an activation function is fixed is used. In contrast to this, it can be seen that the accuracy is restored to an ideal state when a charging element is discharged through the same type of discharge switching element (a polysilicon-based synaptic element) having the same change rate as a weight change over time as in the present disclosure. In the graph on the right, 710 represents an initial state, 720 represents a method of discharging a certain amount according to the known art, and 730 represents a result according to the present disclosure.

As such, according to the present disclosure, a discharge operation of a charging element is performed by using a discharge switching element of the same type as a synaptic element, and thus, an effect of adjusting a gradient of an activation function in response to a change in external environment may be obtained.

In particular, it is possible to obtain an effect of improving the accuracy while performing inference by using an element of the same type as a synaptic element in which weights of a machine learning model are stored.

One embodiment of the present disclosure may also be implemented in the form of a recording medium including instructions executable by a computer, such as a program module executed by the computer. Computer-readable media may be any available media that may be accessed by a computer and include both volatile and nonvolatile media and removable and non-removable media. In addition, the computer-readable media may include all computer storage media. The computer storage media includes both volatile and nonvolatile media and removable and non-removable media implemented by any method or technology of storing information, such as a computer readable instruction, a data structure, a program module, and other data.

Although the method and system according to the present disclosure are described with reference to specific embodiments, some or all of their components or operations may be implemented by using a computer system having a general-purpose hardware architecture.

The above descriptions on the present disclosure are for illustration, and those skilled in the art to which the present disclosure pertains may understand that the descriptions may be easily modified into other specific forms without changing the technical idea or essential features of the present disclosure. Therefore, it should be understood that the embodiments described above are illustrative in all respects and not restrictive. For example, each component described as a single type may be implemented in a dispersed form, and likewise components described as distributed may be implemented in a combined form.

The scope of the present disclosure is indicated by the following claims rather than the above detailed description, and all changes or modifications derived from the meaning and scope of the claims and their equivalents should be interpreted as being included in the scope of the present disclosure.

What is claimed is:

1. A neuromorphic device comprising:
a synaptic array; and
a neuron circuit connected to the synaptic array, configured to accumulate an output current of the synaptic array, and configured to output a spike pulse when the accumulated current exceeds a threshold value,
wherein a discharge switching element for discharging the current accumulated in the neuron circuit includes a synaptic element of the same type as an element included in the synaptic array.

2. The neuromorphic device of claim 1, wherein
the discharge switching element compensates for a change in synaptic weight stored in the synaptic array according to a change in external environment.

3. The neuromorphic device of claim 1, wherein
the discharge switching element provides an effect of adjusting a gradient of an activation function implemented by the neuron circuit according to a change in external environment.

4. The neuromorphic device of claim 1, wherein
the discharge switching element adjusts a gradient of an activation function implemented by the neuron circuit according to a change in external environment, reduces the gradient of the activation function according to an operation of the discharge switching element when an environmental change in which a weight stored in a synapse increases occurs, and increases the gradient of the activation function according to the operation of the discharge switching element when the environmental change in which the weight stored in the synapse decreases occurs.

5. The neuromorphic device of any one of claim 2, wherein
a temperature change or a time change is reflected in an external environment change factor.

6. The neuromorphic device of any one of claim 3, wherein
a temperature change or a time change is reflected in an external environment change factor.

7. The neuromorphic device of any one of claim 4, wherein
a temperature change or a time change is reflected in an external environment change factor.

8. The neuromorphic device of claim 1, wherein the neuronal circuit includes:
an accumulator configured to be driven according to an output current of the synaptic array and configured to charge a charging element with the output current of the synaptic array;
a spike generator configured to transmit a charging voltage of the charging element to an output terminal thereof; and
a discharger configured to discharge the charging element by using the discharge switching element during a spike generating operation of the spike generator.

9. The neuromorphic device of claim 8, wherein
the discharger includes a current mirror configured with a first switching element and a second switching element, and the discharge switching element,
the discharge switching element is switched by an output terminal of the spike generator,
the first switching element has one terminal connected to an output terminal of the charging element and the other terminal that is grounded, and
the second switching element has one terminal connected to the other terminal of the discharge switching element and the other terminal that is grounded.

10. A neuron circuit that is used in a neuromorphic device,
wherein the neuron circuit is coupled to a synaptic array and accumulates an output current of the synaptic array and outputs a spike pulse when the accumulated current exceeds a threshold value, and
a discharge switching element for discharging the current accumulated in the neuron circuit includes a synaptic element of the same type as an element included in the synaptic array.

11. The neuron circuit of claim 10, wherein
the discharge switching element compensates for a change in synaptic weight stored in the synaptic array according to a change in external environment.

12. The neuron circuit of claim 10, wherein
the discharge switching element provides an effect of adjusting a gradient of an activation function implemented by the neuron circuit according to a change in external environment.

13. The neuron circuit of claim 12, wherein
the discharge switching element adjusts a gradient of an activation function implemented by the neuron circuit according to a change in external environment, reduces the gradient of the activation function according to an operation of the discharge switching element when an environmental change in which a weight stored in a synapse increases occurs, and increases the gradient of the activation function according to the operation of the discharge switching element when the environmental change in which the weight stored in the synapse decreases occurs.

14. The neuron circuit of any one of claim 11, wherein
a temperature change or a time change is reflected in an external environment change factor.

15. The neuron circuit of any one of claim 12, wherein
a temperature change or a time change is reflected in an external environment change factor.

16. The neuron circuit of any one of claim 13, wherein
a temperature change or a time change is reflected in an external environment change factor.

17. The neuron circuit of claim 10, wherein the neuronal circuit includes:
an accumulator configured to be driven according to an output current of the synaptic array and configured to charge the output current of the synaptic array in a charging element through a current mirror circuit;
a spike generator configured to amplify a charging voltage of the charging element and transmits amplified charging voltage to an output terminal thereof; and
a discharger including the discharge switching element for discharging the charging element according to a voltage of the output terminal.

18. The neuron circuit of claim 17, wherein
the discharger includes a current mirror configured with a first switching element and a second switching element, and the discharge switching element,
the discharge switching element is switched by an output terminal of the spike generator,
the first switching element has one terminal connected to an output terminal of the charging element and the other terminal that is grounded, and
the second switching element has one terminal connected to the other terminal of the discharge switching element and the other terminal that is grounded.
